(19) United States
(12) Patent Application Publication
(10) Pub. No.: US 2010/0151228 A1
(43) Pub. Date: Jun. 17, 2010

(54) REWORKABLE LIQUID CRYSTAL FILM AND MANUFACTURING METHOD THEREOF

(75) Inventors: Chih-Lung CHIN, Longtan Township (TW); Chang-Hung WU, Guanyin Township (TW); Shih-Hsien LIU, Jhubei City (TW); Kung-Lung CHENG, Hsinchu (TW); Yih-Her CHANG, Hsinchu City (TW); Jer-Young CHEN, Hsinchu City (TW); Ching-Yu CHEN, Hsinchu City (TW)

Correspondence Address: LOWE HAUPTMAN HAM & BERNER, LLP, 1700 DIAGONAL ROAD, SUITE 300, ALEXANDRIA, VA, 22314, US

(73) Assignee: INDUSTRIAL TECHNOLOGY RESEARCH INSTITUTE, Hsinchu (TW)

(21) Appl. No.: 12/418,545

(22) Filed: Apr. 3, 2009

(30) Foreign Application Priority Data
Dec. 15, 2008 (TW) 097148718

(51) Int. Cl. B32B 5/16; B32B 27/40; B32B 27/30; B32B 27/36; B05D 3/00; B32B 37/14

(52) U.S. Cl. 428/323; 428/423.1; 428/523; 428/480; 428/336; 427/385.5; 156/60

(57) ABSTRACT

The invention provides a reworkable liquid crystal film, including a first substrate, a first conductive layer disposed on the first substrate, and a liquid crystal layer disposed on the first conductive layer. The liquid crystal layer contains microencapsulated liquid crystal droplets dispersed in a thermoplastic polymer matrix. The invention also provides a method for forming the reworkable liquid crystal film.

### CROSS REFERENCE TO RELATED APPLICATIONS

This application claims priority of Taiwan Patent Application No. 097148718, filed on Dec. 15, 2008, the entirety of which is incorporated by reference herein.

### BACKGROUND OF THE INVENTION

1. Field of the Invention

The present invention relates to a liquid crystal film, and in particular relates to a reworkable, electrically switchable liquid crystal film.

2. Description of the Related Art

Smart glass, or so-called switchable window, refers to an electrically switchable glass which changes light transmission properties when voltage is applied. A thin layer of liquid crystals is sandwiched between two layers of glass or plastic that include a layer of a transparent, conductive material as electrodes. With no applied voltage, the liquid crystals are randomly arranged, resulting in scattering of light as it passes through the liquid crystal layer. This results in a translucent, “milky white” appearance. When a voltage is applied to the electrodes, the electric field formed between the two transparent electrodes on the glass causes the liquid crystals to align, thereby allowing light to pass through with very little scattering, resulting in a transparent state. The degree of transparency can be controlled by the applied voltage. Smart glass is applied in aircrafts, automobiles, architectural glass, outdoor advertising modules, bathrooms, conference rooms, and video walls.

The liquid crystal used in conventional smart glass is a polymer dispersed liquid crystal (PDLC) film, wherein the liquid crystals are dissolved or dispersed into a liquid polymer followed by solidification or curing of the polymer. During curing of the polymer, the liquid crystals become incompatible with the solid polymer and form droplets throughout the solid polymer. However, the PDLC film tends to have obvious light leakage when pressed or bent, which make it undesirable for curved-surface applications such as car windshields. This phenomena could be attributed to the non-uniformity in size of liquid crystal droplets formed by the curing process. Furthermore, the PDLC film cannot be fabricated by a continuous roll-to-roll process, and is not detachable, i.e., not reworkable.

Accordingly, it would be desirable to provide a reworkable, electrically switchable liquid crystal film which can be fabricated by a continuous roll-to-roll process and has reduced or no light leakage when pressed or bent.

### BRIEF SUMMARY OF THE INVENTION

The invention provides a reworkable liquid crystal film, comprising: a first substrate; a first conductive layer disposed on the first substrate; and a liquid crystal layer disposed on the first conductive layer, wherein the liquid crystal layer comprises microencapsulated liquid crystal droplets dispersed in a thermoplastic polymer.

The invention also provides a method for forming a reworkable liquid crystal film, comprising: mixing microencapsulated liquid crystal droplets with an adhesive to provide a liquid crystal coating material, wherein the adhesive is an aqueous solution of a thermoplastic polymer; coating the liquid crystal coating material onto a substrate with a conductive layer thereon; and drying the liquid crystal coating material to form a dried film.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a flow chart showing the method for forming a liquid crystal film according to an embodiment of the invention;

FIG. 2 is a schematic view showing an apparatus for forming the liquid crystal film of the invention by a continuous roll-to-roll process;

FIG. 3 is a cross-sectional view of the liquid crystal film according to an embodiment of the invention;

FIG. 4 is a cross-sectional view of the liquid crystal film according to another embodiment of the invention;

FIGS. 5-9 are transmission-versus-voltage curves for the liquid crystal films of Examples 1-2 and a commercial product; and

FIG. 10 shows transmission-versus-voltage curves for the liquid crystal films of Example 7.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention involves mixing microencapsulated liquid crystal droplets with thermoplastic polymer adhesive to provide a liquid crystal coating material. The electrically switchable liquid crystal film of the invention can be delaminated/relaminated and has reduced or no light leakage when pressed or bent, thereby providing a higher degree of concealment. Furthermore, the fabrication processes may be implemented by a large scale area roll-to-roll production line.

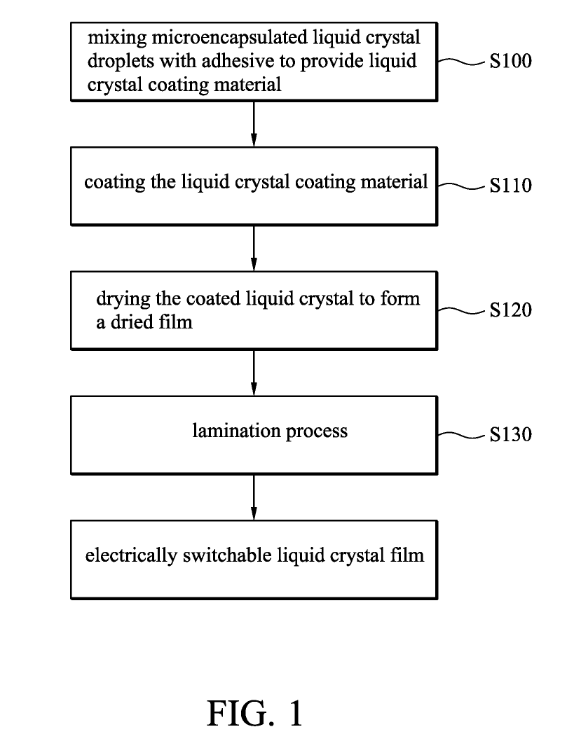

The invention is described in more detail by referring to the flow chart of FIG. 1, which shows the method for forming a liquid crystal film according to an embodiment of the invention. The method begins by mixing microencapsulated liquid crystal droplets with thermoplastic polymer adhesive to provide a liquid crystal coating material (step S100). For the conventional polymer dispersed liquid crystal (PDLC), the liquid crystal material is directly dispersed in polymeric resin. On the other hand, for the polymer dispersed microencapsulated liquid crystal (PDMLC) used in the invention, the liquid crystal material is microencapsulated by a capsule wall to form liquid crystal microcapsules dispersed in polymeric resin. The liquid crystal material to be microencapsulated may be either nematic, cholesteric, smectic, or ferroelectric. The capsule wall may be composed of polyurethane, polyurea, polyacrylate, polyacrylic acid, epoxy resin, polyester, or their combinations. Information relevant to microencapsulated liquid crystals and fabrication methods thereof can be found in U.S. Pat. No. 6,120,701, the entirety of which is incorporated by reference herein. The size of the microencapsulated liquid crystal droplets is about 1-6 μm. A slurry containing the synthesized liquid crystal microcapsules can be centrifuged to obtain narrow particle size distribution, which is an important advantage afforded by the microencapsulated liquid crystals.

The polymeric adhesive used herein is an aqueous solution of a thermoplastic polymer, which preferably has a concentration of about 5-35%, more preferably about 10-30% (by weight). Suitable thermoplastic polymers include, but are not limited to, polyvinyl alcohol (PVA), polyurethane (PU), polyacrylic acid (PAA), polyvinyl pyrrolidone (PVP), polyvinyl acetate (PVAc), or combinations thereof, wherein polyvinyl alcohol (PVA) is particularly preferred. In one example, a thermoplastic polymer with a weight-average molecular weight of about 27000-32000, and an average degree of polymerization of about 550-650 is used. According to a feature of the invention, a thermoplastic polymer of low ion content is preferably used as an adhesive. For example, the level of ion content is preferably lower than 100 ppm, more preferably lower than 1000 ppm. The use of a low ion content thermoplastic polymer can reduce leakage current, thus improving the performance of the electrically switchable liquid crystal film.

In one embodiment, microencapsulated liquid crystal and thermoplastic polymer adhesive are uniformly mixed at a weight ratio of about 1:1-3 at room temperature. The liquid crystal coating material thus formed may have a solid content of about 20-60%, preferably about 30-50%, and a viscosity at 25° C. of about 800-2000 cps, preferably about 1000-1200 cps.

Thereafter, the liquid crystal coating material containing the microencapsulated liquid crystal droplets and thermoplastic polymer adhesive is coated on a substrate having a conductive layer thereon, for example, an indium tin oxide coated polyester (ITO-PET) film (step S110). The coated liquid crystal material is then dried into a liquid crystal film (step S120), and then laminated with another substrate having a conductive layer thereon to provide the electrically switchable liquid crystal film of the invention (step S130).

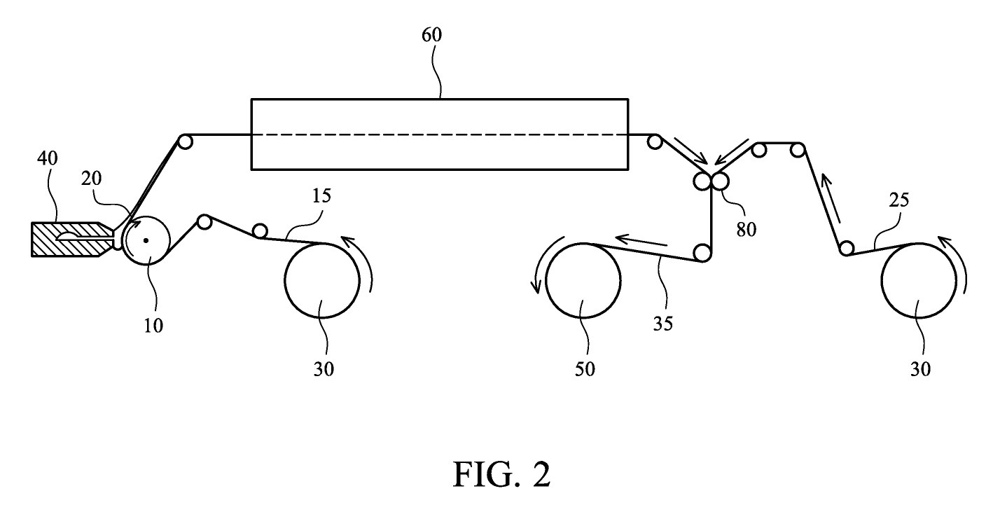

The fabrication steps S110, S120, S130 are preferably carried out by a roll-to-roll process to provide a continuous liquid crystal film roll. FIG. 2 is an example of a roll-to-roll apparatus for fabricating the liquid crystal film. As shown in FIG. 2, an ITO-PET film 15 is unwound by a dispenser roller 30 and continuously carried at a fixed speed of, for example, about 2-4 m/min. Through a slot die 40, the liquid crystal coating material 20 obtained from step S100 is coated onto the ITO-PET film 15 at roller 10. The coated film is subsequently dried when passing through a drying oven 60. The coated film may be dried in the oven by a multi-stage drying process with temperatures ranging from about 40-90° C. Thereafter, the dried coating film is laminated with another ITO-PET film 25 by a heat roller 80 to give the desired electrically switchable liquid crystal film 35, which is then rolled onto a take-up roller 50. It should be noted that FIG. 2 merely shows a representative roll-to-roll apparatus for practicing the invention. Apparatuses other than that shown in FIG. 2 can be used to practice the invention.

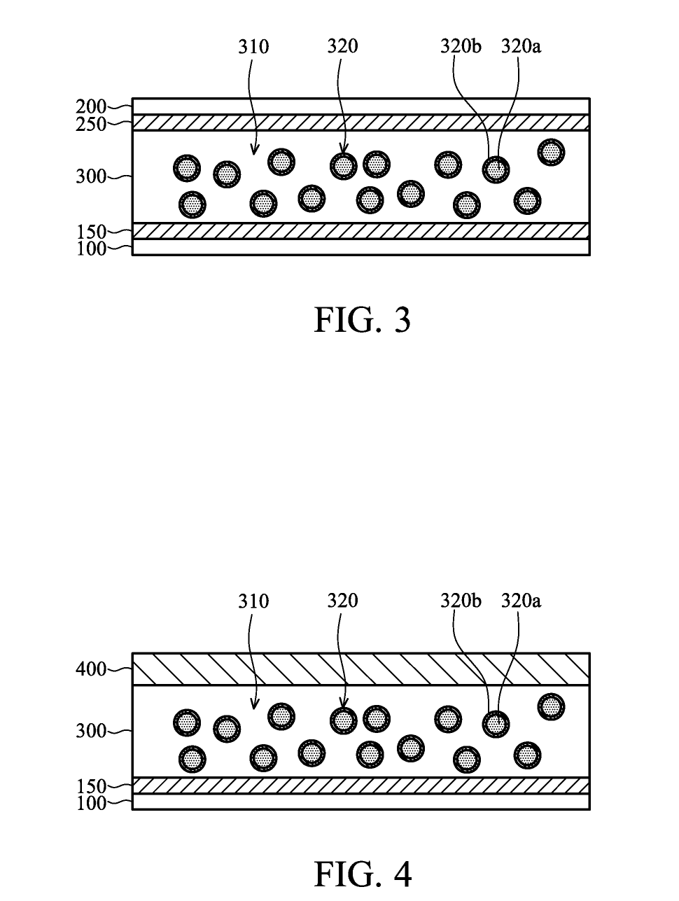

FIG. 3 is a cross-sectional view of the liquid crystal film according to an embodiment of the invention. As shown, the electrically switchable liquid crystal film includes a first substrate 100, a first conductive layer 150 disposed on the first substrate 100, and a liquid crystal layer 300 disposed on the first conductive layer 150. The liquid crystal layer 300 contains a plurality of microencapsulated liquid crystal droplets 320 dispersed in a thermoplastic polymer 310, wherein the microencapsulated liquid crystal droplets 320 are composed of a capsule wall 320b and the liquid crystal molecules 320a enclosed in the capsule. The microencapsulated liquid crystal droplets 320 and the thermoplastic polymer 310 in the liquid crystal layer 300 are preferably present at a weight ratio of about 1:2, and more preferably about 1:1.5. Above the liquid crystal layer film, there is further provided a second conductive layer 250 and a second substrate 200. The first and second conductive layers 150, 250 serve as electrodes that control the alignment direction of the liquid crystal molecules 320a. When no voltage is applied, the liquid crystal molecules 320a are randomly arranged in the droplets 320, resulting in scattering of light as it passes through the liquid crystal layer film 300. As a result, the electrically switchable liquid crystal film is opaque or translucent. When voltage is applied to the electrodes, the liquid crystal molecules 320a align parallel to the applied field, thereby allowing light to pass through the droplets 320 with very little scattering, and the electrically switchable liquid crystal film becomes clear and transparent.

The first and second conductive layers 150, 250 are transparent conductive layers such as indium tin oxide (ITO), indium zinc oxide (IZO), and aluminum-doped zinc oxide (AZO). The first and second substrates 100, 200 can be any transparent polymers such as polycarbonate (PC), poly(ethylene 2,6-naphthalate) (PEN), polyimide (PI), and poly(ether sulfone) (PES). Additionally, if a continuous roll-to-roll process is not applied, rigid transparent substrates such as glass may be used. The thickness of the liquid crystal layer 300 may range from about 10 μm to about 20 tμto cope with the demand of high transparency (thin film) or high shielding (thick film). The thickness may be adjusted by controlling the viscosity of the coating material, the width of the slot die, the feeding speed of the substrate, and so on.

One advantage of the electrically switchable liquid crystal film of the invention is that it exhibits a remarkably reduced light leakage when being pressed or bent. This result is attributed to the narrow size distribution of the microencapsulated liquid crystal droplets and the fact that the liquid crystals enclosed in the capsule are less flowable or deformable due to external forces. This feature allows the electrically switchable liquid crystal film to be used on a curved surface such as car windshields, architectural glass, or other shaped glass with a non-planar surface. By contrast, conventional electrically switchable liquid crystal films may substantially lose the switchable characteristic due to significant light leakage when applied to curved surfaces.

Another advantage of the electrically switchable liquid crystal film of the invention is the reworkable property; that is, it can be delaminated and reprocessed. Because the adhesive used herein is a thermoplastic polymer, the second substrate 200 (including the second conductive layer 250 thereon) laminated on the liquid crystal layer 300 is readily detachable and can be relaminated without adversely affecting the electro-optical performance. By contrast, conventional electrically switchable liquid crystal films that use thermoset polymer adhesives such as epoxy resins, are not detachable once laminated on a substrate, thus they are not suited for rework or further processing.

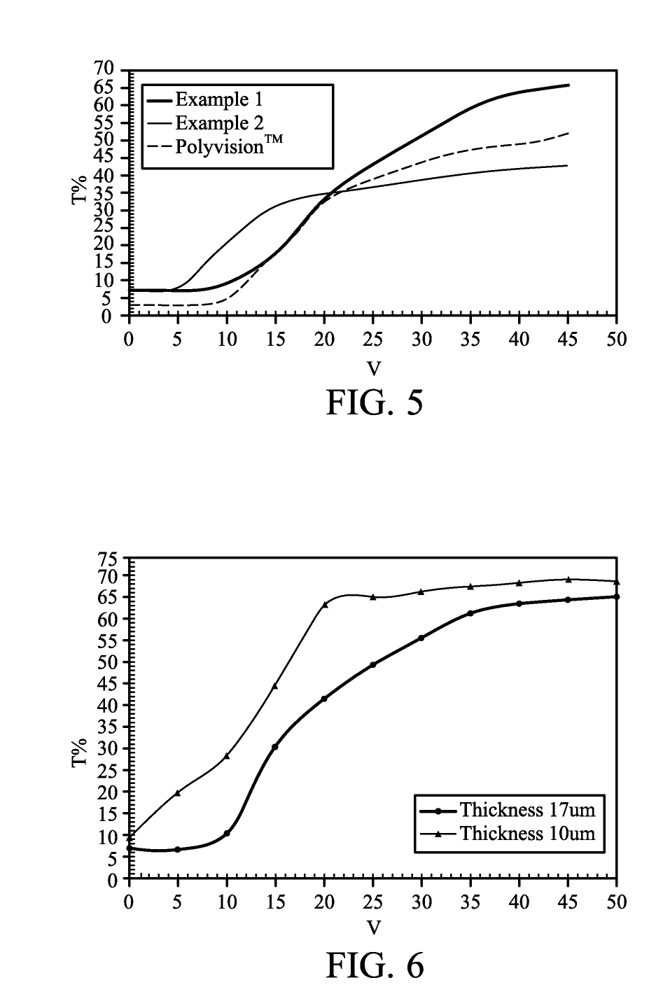

Referring to FIG. 4, a cross-sectional view of the liquid crystal film according to another embodiment of the invention is shown. In this embodiment, the second substrate 200 and the second conductive layer 250 of FIG. 3 that overly the liquid crystal layer 300 are replaced by a release film 400. The release film can be made of PET, polypropylene (PP), polyethylene (PE), polyvinyl chloride (PVC), or silicone. The release film preferably has a thickness of about 10-100 μm. A liquid crystal film with a release film attached thereto can be fabricated simply by replacing the ITO-PET film 25 of FIG. 2 with a release film. The product containing the release film can be cut into a suitable size after the size of a demanded smart window is determined. After cutting, the release film 400 can be removed from the surface of the liquid crystal layer 300, and then an ITO-PET film or other conductive substrates (such as ITO-glass substrate) of a predetermined size can be laminated, thus providing process adjustability.

### SYNTHETIC EXAMPLE

2.5g of polyurethane (Desmodur N-3200 manufactured by Bayer Corp.) and 40 g of liquid crystal (DII-032 manufactured by the Industrial Technology Research Institute, Taiwan, Δn=0.19, Tc=89° C.) were mixed at 60° C. The solution was then poured into a solution of 200 g of 10% polyvinyl alcohol, which was undergoing constant stirring, and was emulsified at 3000 rpm, 50 to 55° C. for 3 minutes to obtain the particle size of 1 to 10 μm. 25 g of 10% triethylene diamine and 25 g of 10% triethanol amine were added to the solution and stirred at 55° C. for 10 hours. After the reaction was complete, 20 g of 10% ammonium hydroxide was added to the solution and then the solution was allowed to stand overnight. The resulting slurry was centrifuged at 5000 rpm to obtain a microencapsulated liquid crystal of narrow particle size distribution of 1 to 5 μm.

### EXAMPLE 1

At room temperature, the microencapsulated liquid crystal of the Synthetic Example was mixed with an aqueous solution of 20% polyvinyl alcohol at a weight ratio of 1:1.5 to obtain a liquid crystal coating material having a solid content of 42%, and a viscosity of 1000-1100 cps (at 25° C.). For the mixed aqueous solution, the polyvinyl alcohol weight-average molecular weight was 27000-32000, the average degree of polymerization was 550-650, and the sodium ion content was below 60ppm.

Using the apparatus as shown in FIG. 2, the liquid crystal coating material was coated on an ITO-PET film by a slot die (coating width: 1.1 m) at a line speed of 4 m/min, dried in an oven by a five-stage drying process with temperatures ranging from 40 to 90° C., and then laminated with another ITO-PET film by heat rollers at about 100° C., thus obtaining an electrically switchable liquid crystal film with a thickness of 15 μm.

### EXAMPLE 2

The same procedure as described in Example 1 was repeated to obtain an electrically switchable liquid crystal film, except that the liquid crystal coating material was prepared by mixing the microencapsulated liquid crystal with a 20% polyvinyl alcohol aqueous solution and a 20% polyurethane aqueous solution at a weight ratio of 1:1.29:0.21. The resulting coating material had a solid content of 42% and a viscosity of 800-900 cps (at 25° C.).

### EXAMPLE 3

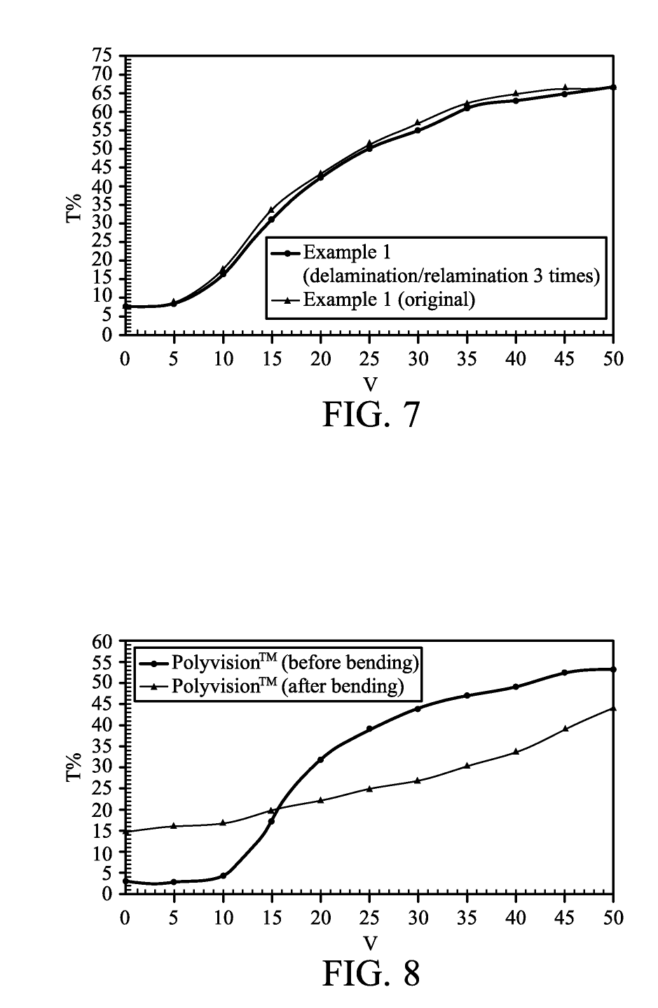

Each of the electrically switchable liquid crystal films of Examples 1-2 was cut into a suitable size and bonded with two glass sheets on opposite sides to obtain an electrically switchable glass (size: 1.1 m×3 m). The opto-electrical characteristic of the electrically switchable glass was measured by a transparency meter (manufactured by EDTM Inc.), and the results are shown in FIG. 5. As can be seen, the electrically switchable liquid crystal film of Example 1 exhibited a higher transmission (T %=65% at 45V) than the commercial product “Polyvision™” (T %=54% at 45V, available from Polytronix, Inc.).

### EXAMPLE 4

The same procedure as described in Example 1 was repeated except that the distance between the slot die and the ITO-PET substrate was changed to prepare electrically switchable liquid crystal films of different thicknesses (dry film thickness: 10 μm and 17 μm, not including the substrate thickness). Each of the electrically switchable liquid crystal films was cut into a suitable size and bonded with two glass sheets on opposite sides to obtain an electrically switchable glass. The opto-electrical characteristic was measured and the results are shown in FIG. 6 and the following table.

Transmission (%)

| Applied voltage | Thickness: 17 μm | Thickness: 10 μm |
|---|---|---|
| 0 V | 7 | 10 |
| 50 V | 66 | 70 |

As can be seen, the thick film (17 μm) showed a relatively poor transmission (7%-66%) or higher shielding, while the thin film (10 μm) showed a relatively higher transmission (10%-70%) or poor shielding.

### EXAMPLE 5

The ITO-PET substrate of the electrically switchable liquid crystal film of Example 1 was delaminated and relaminated for three times, wherein the relamination was carried out by a laminator at 100° C. The relaminated sample was measured for the opto-electrical characteristic. As shown in FIG. 7, the opto-electrical characteristic was almost unchanged as compared to the original sample.

### EXAMPLE 6

A commercial smart glass product “Polyvision™” from Polytronix, Inc. (21 cm×8 cm in size) was bent into a hollow cylindrical shape (6cm in diameter), and measured for the opto-electrical characteristic. As shown in FIG. 9, when no voltage was applied, the commercial product showed a transmission of 3% before bending. However, the transmission was significantly increased by 12%, to 15% after bending.

Likewise, the electrically switchable liquid crystal film of Example 1 of the same size (21 cm×8 cm) was bent into a hollow cylindrical shape (6 cm in diameter), and measured for the opto-electrical characteristic. As shown in FIG. 9, when no voltage was applied, the transmission was 6% before bending, and slightly increased by 1%, to 7% after bending. This unique features allows the electrically switchable liquid crystal film of the invention to be applied on a curved surface without substantial light leakage to maintain a high degree of concealment.

### EXAMPLE 7

The same procedure as described in Example 1 was repeated to obtain the liquid crystal coating material, except that 20% polyvinyl alcohol aqueous solutions with a low ion content (below 60 ppm) and a high ion content (above 3600 ppm) were used, respectively. Each of the obtained liquid crystal coating material was coated on an ITO-PET film by blade coating, oven dried at about 80-90° C. for 7 minutes, and then laminated with another ITO-PET film by a laminator at about 100° C., thus obtaining an electrically switchable liquid crystal film with a thickness of 8 μm and 15 μm, respectively.

### EXAMPLE 8

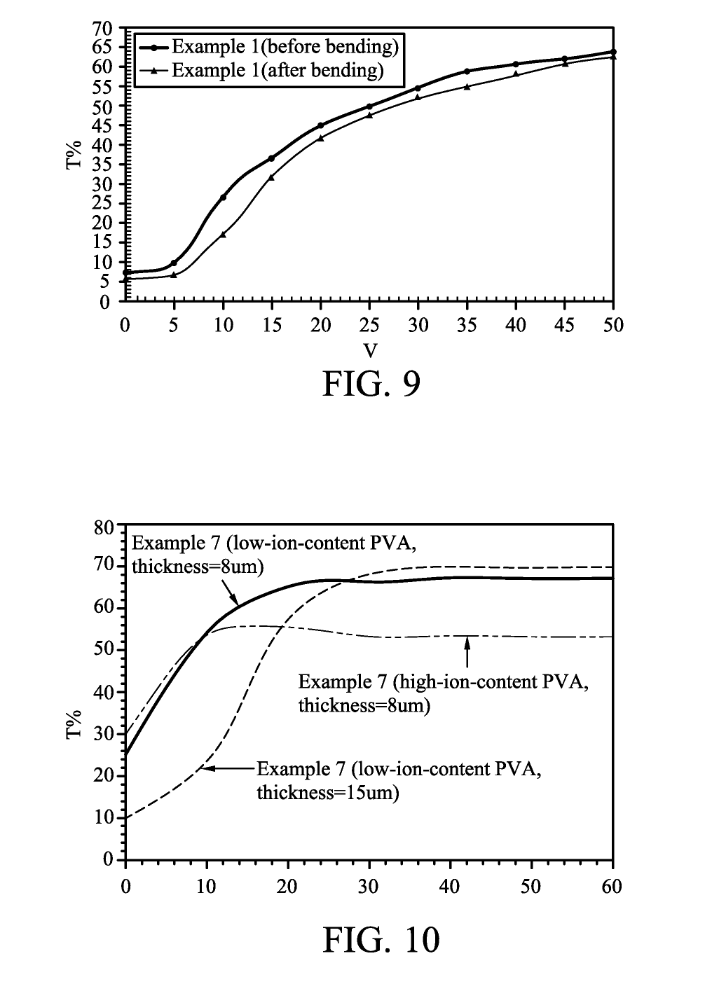

Each of the electrically switchable liquid crystal films of Example 7 was cut into a suitable size and bonded with two glass sheets on opposite sides to obtain an electrically switchable glass (size: 1.1 m×3 m). The opto-electrical characteristic of the electrically switchable glass was measured by a transparency meter (manufactured by EDTM Inc.), and the results are shown in FIG. 10. As can be seen, the electrically switchable liquid crystal film (thickness: 8 μm and 15 μm) made from the low-ion-content PVA solution exhibited a higher transmission than that made from the high-ion-content PVA solution. Furthermore, with a thickness above 15 μm, the electrically switchable liquid crystal film made from the high-ion-content PVA solution was burnt out and substantially lost the switchable function after several times of voltage application.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A reworkable liquid crystal film, comprising
a first substrate;
a first conductive layer disposed on the first substrate; and
a liquid crystal layer disposed on the first conductive layer, wherein the liquid crystal layer comprises microencapsulated liquid crystal droplets dispersed in a thermoplastic polymer.

2. The reworkable liquid crystal film as claimed in claim 1, wherein the thermoplastic polymer comprises polyvinyl alcohol (PVA), polyurethane (PU), polyacrylic acid (PAA), polyvinyl pyrrolidone (PVP), polyvinyl acetate (PVAc), or combinations thereof.

3. The reworkable liquid crystal film as claimed in claim 1, wherein the thermoplastic polymer has an ion content of less than 100 ppm.

4. The reworkable liquid crystal film as claimed in claim 1, wherein the thermoplastic polymer has an ion content of less than 1000 ppm.

5. The reworkable liquid crystal film as claimed in claim 1, wherein the thermoplastic polymer has a weight-average molecular weight of about 27000-32000.

6. The reworkable liquid crystal film as claimed in claim 1, wherein the thermoplastic polymer has an average degree of polymerization of about 550-650.

7. The reworkable liquid crystal film as claimed in claim 1, wherein the liquid crystal layer has a thickness of about 10-20 μm.

8. The reworkable liquid crystal film as claimed in claim 1, further comprising a second conductive layer disposed on the liquid crystal layer, and a second substrate disposed on the second conductive layer.

9. The reworkable liquid crystal film as claimed in claim 1, further comprising a release film disposed on the liquid crystal layer.

10. The reworkable liquid crystal film as claimed in claim 1, wherein the microencapsulated liquid crystal droplets have a particle size of about 1-6 μm.

11. The reworkable liquid crystal film as claimed in claim 1, wherein the first substrate is disposed on a curved surface.

12. A method for forming a reworkable liquid crystal film, comprising
mixing microencapsulated liquid crystal droplets with an adhesive to provide a liquid crystal coating material, wherein the adhesive is an aqueous solution of a thermoplastic polymer;
coating the liquid crystal coating material onto a substrate with a conductive layer thereon; and
drying the liquid crystal coating material to form a dried film.

13. The method for forming a reworkable liquid crystal film as claimed in claim 12, wherein the aqueous solution has a concentration of about 5-35%.

14. The method for forming a reworkable liquid crystal film as claimed in claim 12, wherein the aqueous solution has a concentration of about 10-30%.

15. The method for forming a reworkable liquid crystal film as claimed in claim 12, wherein the liquid crystal coating material has a solid content of about 20-60%.

16. The method for forming a reworkable liquid crystal film as claimed in claim 12, wherein the thermoplastic polymer comprises polyvinyl alcohol (PVA), polyurethane (PU), polyacrylic acid (PAA), polyvinyl pyrrolidone (PVP), polyvinyl acetate (PVAc), or combinations thereof.

17. The method for forming a reworkable liquid crystal film as claimed in claim 12, wherein the thermoplastic polymer has an ion content of less than 1000 ppm.

18. The method for forming a reworkable liquid crystal film as claimed in claim 12, wherein the thermoplastic polymer has an ion content of less than 100 ppm.

19. The method for forming a reworkable liquid crystal film as claimed in claim 12, wherein the liquid crystal coating material is dried at a temperature of about 40-90° C.

20. The method for forming a reworkable liquid crystal film as claimed in claim 12, further comprising laminating the dried film with another substrate with a conductive layer thereon.

21. The method for forming a reworkable liquid crystal film as claimed in claim 12, further comprising laminating the dried film with a release film.

22. The method for forming a reworkable liquid crystal film as claimed in claim 12, which is implemented on a continuous, roll-to-roll process.

23. The method for forming a reworkable liquid crystal film as claimed in claim 12, further comprising attaching the liquid crystal film onto a curved surface.
